(19) United States
(12) Patent Application Publication
(10) Pub. No.: US 2004/0172551 A1
(43) Pub. Date: Sep. 2, 2004

(54) First response computer virus blocking.

(75) Inventors: Alex Fielding, Half Moon Bay, CA (US); Michael James Connor, El Dorado Hills, CA (US)

Correspondence Address: Michael James Connor, 4359 Cordero Drive, El Dorado Hills, CA, 95762

(73) Assignees: Michael James Connor, El Dorado Hills, CA (US); Alex Fielding, Half Moon Bay, CA (US)

(21) Appl. No.: 10/707,363

(22) Filed: Dec. 9, 2003

(51) Int. Cl. G06F 11/30

(52) U.S. Cl. 713/200; 713/176

(57) ABSTRACT

A process of screening one or more software files to determine any that are recognized to have a matching hash signature with a file contained in a database of files known to be Virus, Trojan, Worm, or otherwise potentially malicious or suspicious which then can be safely blocked, quarantined and/or deleted. This is accomplished through a method and apparatus running on a firewall, network device, mail server, server, personal computer, PDA, cell phone or wireless device to compare the hash signature of each incoming software file against a regularly updated database of known infected file hash signatures. One or more users can be alerted when an infected file is identified. If quarantined the file is safely stored until virus software is updated properly with later developed virus definitions file(s), which are then used to eradicate or clean the infected file(s) or computer systems.

### CROSS REFERENCE TO RELATED APPLICATIONS

### BACKGROUND OF INVENTION

Electronic/computer data viruses represent a potentially serious liability to all electronic data users and especially to those who regularly transfer data between computers. Computer viruses were first identified in the 1980's, and up until the mid-1990s consisted of a piece of executable code which attached itself to a bona fide computer program. At that time, a virus typically inserted a JUMP instruction into the start of the program which, when the program was executed, caused a jump to occur to the “active” part of the virus. In many cases, the viruses were inert and activation of a virus merely resulted in its being spread to other bona fide programs. In other cases however, activation of a virus could cause malfunctioning of the computer running the program including, in extreme cases, the crashing of the computer and the loss of data.

Computer software intended to detect (and in some cases disinfect) infected programs has in general relied as a first step upon identifying those data files which contain executable code, e.g. .exe, .com, .bat. Once identified, these files are searched (or parsed) for certain signatures which are associated with known viruses. The producers of anti-virus software maintain up to date records of such signatures which may be, for example, checksums.

WO95/12162 describes a virus protection system in which executable data files about to be executed are passed from user computers of a computer network to a central server for virus checking. Checking involves parsing the files for signatures of known viruses as well as for signatures of files known to be clean (or uninfected).

U.S. Pat. No. 6,577,920 describes a virus protection system in which data files are scanned to determine if they contain macro code which matches the hash signature of known macro viruses. This does not take into account the complete hash signature or checksum of larger files or executable applications.

There are a number of problems with these more or less conventional approaches. There is inevitably a time lag between a virus being released and identified and the development and release of an updated virus definitions file. By this time many computers may have been infected. Secondly, end users may be slow in updating their systems with the latest virus definitions. Again, this leaves a large window of opportunity for systems to become infected.

WO 98/14872 describes an anti-virus system which uses a database of known virus signatures as described above, but which additionally seeks to detect unknown viruses based upon expected virus properties. However, given the ingenuity of virus producers, such a system is unlikely to be completely effective against unusual and exotic new viruses.

U.S. Pat. No. 6,577,920 describes an anti-virus system which uses multiple databases to determine a hash specific to a macro virus such as those found in Microsoft Office documents that contain macros. The problem with this approach, while effective for some viruses, is that it limits the scope of using checksums for all other types of infected or malicious files.

The other problem unchanged by U.S. Pat. No. 6,577,920 and WO 98/14872 is the multiple hours to days that are spent while anti-virus companies develop, test and release virus definition files for virus scanning software. This time lag can be crippling for Government agencies, corporations or individuals who would prefer to have capability in place to prevent becoming infected in the first place. They all require a much more effective and much faster means to prevent viruses and other malicious software from harming their networks, servers, computers and other electronic devices.

### SUMMARY OF INVENTION

The first object of the present invention is to overcome or at least mitigate the above noted disadvantages of existing anti-virus software.

The second object of the present invention is to block, quarantine, delete and/or perform additional actions on viruses or other malicious files using new methods and apparatus.

According to a first aspect of the present invention there is provided a method of screening a software file for viral infection, the method comprising;

defining a database of signatures of files that are known to contain a virus.

scanning said file to determine whether or not the file has a signature corresponding to one of the signatures contained in said database.

The present invention has the significant advantage that it may be used to effectively block the transfer and/or processing of files which contain an identified virus. It is therefore less critical for virus definition files and other software fixes to be updated immediately or for operating systems to be frequently patched to undo damage that has been done.

Preferably, said step of defining a database of signatures of files known to contain a virus or otherwise infected file will be portable enough to be executed quickly even on machines that traditionally would have taken considerable time to scan for said infected files in more conventional ways. More preferably, the step of defining the database comprises the further steps of updating the database with additional signatures. This updating may be done via an electronic link between a computer hosting the database (where the scanning of the file is performed) and a remote central computer. Alternatively, the database may be updated by way of data stored on an electronic storage medium such as a floppy disk, CD, DVD, flash device or other peripheral storage device.

According to a second aspect of the present invention there is provided a method of screening a software file for viral infection, the method comprising:

defining a first database of known macro virus signatures determining a signature for the file and screening that signature against the signatures contained in said databases; and

alerting a user in the event that the file has a signature corresponding to a signature contained in said database.

According to a third aspect of the present invention there is provided an apparatus for screening a software file for viral infection, the apparatus comprising;

a memory storing a set of signatures of files previously identified as containing a virus; and

a data processor arranged to scan said file to determine whether or not the file contains a matching hash.

According to a third aspect of the present invention there is provided a computer memory encoded with executable instructions representing a computer program for causing a computer system to:

maintain a database of signatures of files previously identified as being infected; and

scan data files to determine a hash signature; and

determine whether or not the file has a signature corresponding to one of the signatures contained in said database.

Preferably, the computer program provides for the updating of said database with additional file signatures. More preferably, the computer program provides a mechanism for quarantine of infected files until such a time as an updated virus definition file can be received by anti-virus software to eradicate or repair said quarantined file before any damage could be done to the users computer or data.

According to a fourth aspect of the present invention there is provided apparatus for determining and screening partial file hash signatures of files in transit or in situations where only a partial file is visible from a given device, the apparatus comprising;

a memory storing a set of signatures of partial file(s) previously identified as containing a virus; and

a data processor arranged to scan said partial file(s) to determine whether or not the file(s) contains a matching hash.

According to a third aspect of the present invention there is provided a computer memory encoded with executable instructions representing a computer program for causing a computer system to:

maintain a database of signatures of partial files previously identified as being infected; and

scan partial data files to determine a hash signature; and

determine whether or not the partial file has a signature corresponding to one of the signatures contained in said database.

### BRIEF DESCRIPTION OF DRAWINGS

FIG. 1 is a functional block diagram of the method of computing a file hash signature and comparing it to a database of known file signatures; and

FIG. 2 is a functional block diagram of a computer system in which is installed virus blocking software; and

FIG. 3 is a flow chart illustrating the method of operation of the system of FIG. 2; and

FIG. 4 is a functional block diagram of the method of computing a file hash signature and comparing it to a database of known file signatures when the file is in transit and is broken into several data streams.

### DETAILED DESCRIPTION

For the purpose of illustration, the following example is described with reference to the Apple Macintosh OS X.™ series of operating systems, although it will be appreciated that the invention is also applicable to other operating systems including Microsoft Windows.™ series operating systems, Apple Macintosh 9 systems, Linux, Unix, SCO, BSD, FreeBSD, Microsoft Windows CE.™, Microsoft Windows NT.™, Microsoft Windows XP.™, IBM AIX and OS/2.

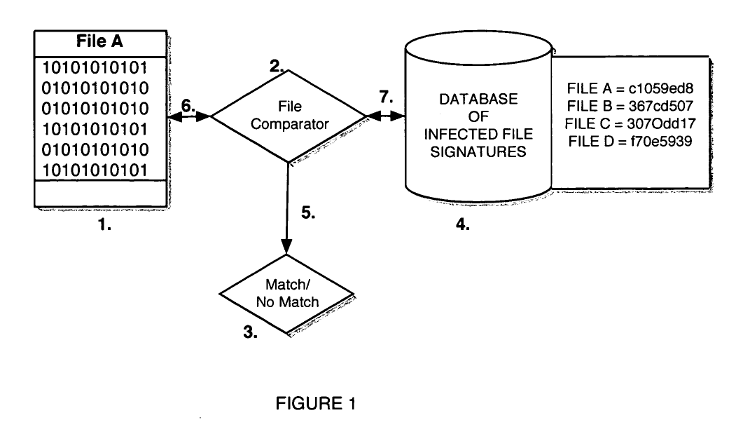

With reference to FIG. 1, a method contained inside of a computer system is described as containing a file 1 that is being interrogated by a file comparator process 2 via an electronic link 6 to compute a hash signature and compare said signature to those contained in a database containing infected file signatures 4. The logical link 7 connecting the two processes and the file comparator 2 returning a result 3 of MATCH or NO MATCH.

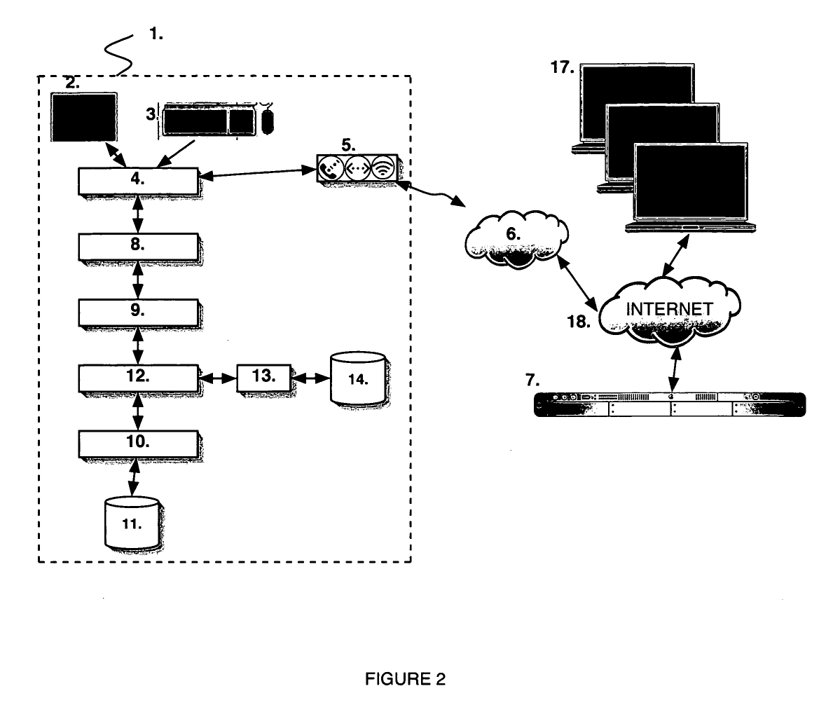

With reference to FIG. 2, an end user computer 1 has a display 2 and a keyboard 3. The computer 1 additionally has a processing unit and a memory which provide (in functional terms) a graphical user interface layer 4 which provides data to the display 2 and receives data from the keyboard 3. The graphical user interface layer 4 is able to communicate with other computers via a network interface 5 and a network 6. The network is controlled by a network manager 7.

Beneath the graphical user interface layer 4, a number of user applications are run by the processing unit. In FIG. 2, only a single application 8 is illustrated and may be, for example, Microsoft Word.™. The application 8 communicates with a file system 9 which forms part of the Apple Macintosh OS X.™ operating system and which is arranged to handle file access requests generated by the application 8. These access requests include file open requests, file save requests, file copy requests, etc. The lowermost layer of the operating system is the disk controller driver 10 which communicates with and controls the computer's hard disk drive 11. The disk controller driver 10 also forms part of the Apple Macintosh OS X.™ operating system.

Located between the file system 9 and the disk controller driver 10 is a file system driver 12 which intercepts file system events generated by the file system 9. The role of the file system driver 12 is to co-ordinate virus screening and blocking operations for data being written to, or read from, the hard disk drive 11. A suitable file system driver 12 is, for example, the GATEKEEPER.™ driver which forms part of the F-SECURE ANTI-VIRUS.™ system available from Data Fellows Oy (Helsinki, Finland). In dependence upon certain screening operations to be described below, the file system driver 12 enables file system events to proceed normally or prevents file system events and issues appropriate alert messages to the file system 9.

The file system driver 12 is functionally connected to a virus print controller 13, such that file system events received by the file system driver 12 are relayed to the virus print controller 13. The virus print controller is associated with a database 14 which contain a set of “signatures” previously determined for respective infected files. For the purposes of this example, the signature used is a checksum derived using a suitable checksum calculation algorithm, such as the US Department of Defense Secure Hash Algorithm (SHA, SHA-1, SHA-224), MD5, MD2, or the older CRC 32 algorithm or other open source or proprietary algorithm capable of generating a hash signature value deemed acceptable to determine that one file is an identical copy of another file.

The database 14 contains a set of signatures derived for known viruses. Updates may be provided by way of floppy disks, CD, DVD, flash drive, FireWire, USB, or directly by downloading them from a remote server 17 connected to the Internet 18.

Only the network manager 7 and/or authorized computer administrator has the authority to modify this database 14 using signatures specified by the anti-virus software provider.

Upon receipt of a file system event, the virus print controller 13 first analyses the file associated with the event (and which is intended to be written to the hard disk drive 11, read, copied, etc) to determine if the file matches that of a file identified to contain a virus.

The virus print controller 13 scans the database 14 to determine whether or not the corresponding signature is present in that database 14. If the signature is found there, the virus print controller 13 reports this to the file system driver 12. The file system driver 12 in turn causes the system event to be suspended and causes an alert to be displayed to the user that a known virus is present in the file. The file system driver 12 may also cause a report to be sent to the network manager 7 via the local network 6. The file system driver 12 quarantines the infected file on the hard disk drive 11.

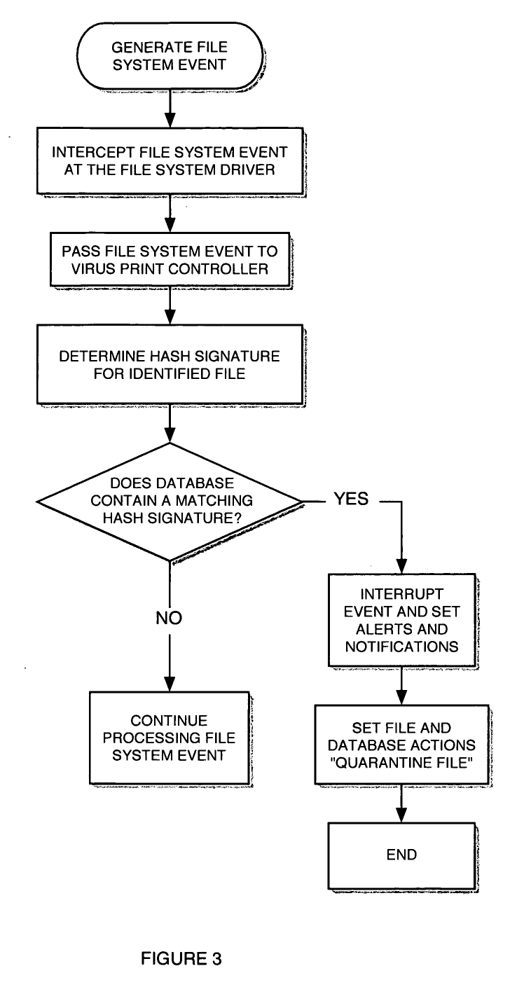

The file scanning system described above is further illustrated by reference to the flow chart of FIG. 3.

It will be appreciated by the person of skill in the art that various modifications may be made to the embodiment described above without departing from the scope of the present invention. For example, the file system driver 12 may make use of further virus controllers including controllers arranged to screen files for viruses other than virus print identifiable. The file system driver 12 may also employ disinfection systems and data encryption systems.

It will also be appreciated that the file system driver 12 typically receives all file access traffic, and not only that relating to hard disk access. All access requests may be passed to the virus print controller 13 which may select only hard disk access requests for further processing or may also process other requests relating to, but not limited to, floppy disk data transfers, network data transfers, DVD, DVD-R, DVD-RW, CDROM, CD-RW, CD-R data transfers, USB, USB 2.0, FireWire, FireWire 2, and associated peripheral flash storage devices.

It will also be appreciated that the file system driver 12 and file system 9 along with applications 8 and GUI 4 can be those related to hand held, cell phone, PDA, digital camera, digital storage, or other devices containing a method to process electronic data as described above. It is also appreciated that hard disk drive 11 can be any electronic storage device such as flash, FireWire IEEE 1394, USB, USB 2.0, FireWire 2.0, and other electronic storage devices such as SD, MD, CF, etc. It is also appreciated that keyboard 3 can be any input device such as a cell phone keypad, microphone, or other electronic interface to a computer system or electronic device via wired or wireless connection.

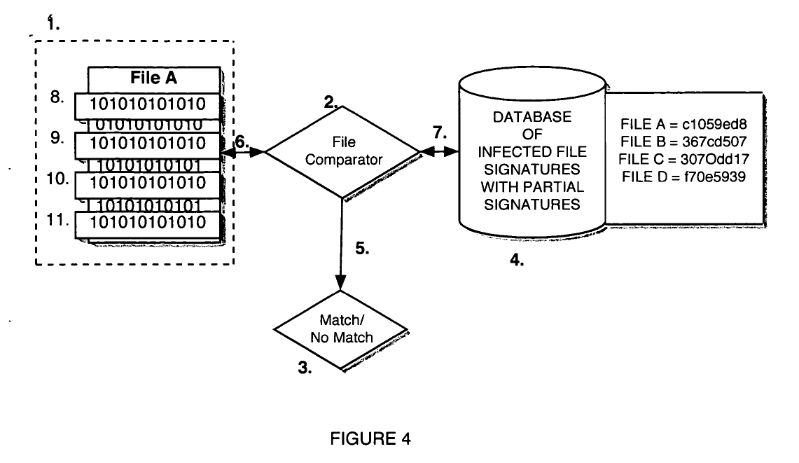

With reference to FIG. 4, a method contained inside of a computer system is described as containing a file 1 that is being interrogated by a file comparator process 2 via an electronic link 6 to compute a hash signature and compare said signature to those contained in a database containing infected file signatures 4. The logical link 7 connecting the two processes and the file comparator 2 returning a result 3 of MATCH or NO MATCH.

In the case of data files in transit or when a complete file is not present or only pieces of a file are available. The file 1 is broken into several smaller blocks 8, 9, 10, and 11, for example, that are computed with unique hash signatures based on their size and location in the file as determined by the file comparator 2. The database 4 also contains hash signatures of these partial blocks wherein, for instance, the first block of data 8 may be a known and preset percentage or piece of the file 1 under interrogation by start, end, and size of the partial file. The database 4 contains a complete hash for the file 1 as well as hash signatures for partial blocks 8, 9, 10, and 11, etc. The file comparator 2 interrogates the database to set starting and ending locations of known blocks of data to determine if itheata atis located the begging of a file 1 such as or the end such as 11. Thus the comparator 2 can compute a hash and compare the hash for the partial file or block of data 8, 9, 10, or 11 f d match it with the appropriate signature location inside the database 4.

1. A method of screening a software file for viral infection, the method comprising:
defining a database of known infected file signatures;
determining a signature for a file; and
screening that signature against the signatures contained in said database to determine if there is a match.

2. A method according to claim 1, wherein a match of signatures between the screened file and said database results in an action affecting the said screened file.

3. A method according to claim 1, wherein the result of a non matching signature between the screened file and said database results in an action affecting the said screened file.

4. A method according to claim 1, wherein the result of a non matching signature between the screened file and said database results in an action affecting the said database.

5. A method according to claim 1, wherein a match of signatures between the screened file and said database results in an action affecting the database.

6. A method according to claim 1, wherein a match of signatures between the screened file and said database results in an alert or notification to a user of a local computer system.

7. A method according to claim 6, wherein the said computer system is connected via an electronic link to a remote central computer.

8. A method according to claim 2, wherein a said action is an electronic quarantine of said matched file.

9. A method according to claim 1, wherein said database is updated via an electronic link between a computer hosting the database, where the scanning of the file is performed, and a remote central computer.

10. A method according to claim 1, wherein said database contains a flag set in memory to quarantine said screened files.

11. A method according to claim 1, wherein said database contains a flag set in memory to release quarantined files.

12. A method according to claim 1, wherein said database contains a flag set in memory to erase said files.

13. A method according to claim 10, wherein said flag can be updated by remote software via an electronic link to end user computers.

14. A method according to claim 11, wherein said flag can be updated by remote software via an electronic link to end user computers.

15. A method according to claim 12, wherein said flag can be updated by remote software via an electronic link to end user computers.

16. A method according to claim 10, wherein said flag can be updated by a network manager and flag updates made by the network manager are communicated to network end user computers where infected file virus screening is performed.

17. A method according to claim 11, wherein said flag can be updated by a network manager and flag updates made by the network manager are communicated to network end user computers where infected file virus screening is performed.

18. A method according to claim 12, wherein said flag can be updated by a network manager and flag updates made by the network manager are communicated to network end user computers where infected file virus screening is performed.

19. A method according to claim 10, wherein the quarantined file is placed in a non-executable electronic container.

20. A method according to claim 1, wherein the user is a network manager and database updates made by the network manager are communicated to network end user computers where infected file virus screening is performed.

21. A method according to claim 1, wherein said step of determining a signature for the file and screening that signature comprises deriving a signature of the file and comparing the derived signature with signatures in the database.

22. Apparatus for screening a software file for viral infection, the apparatus comprising:
a memory storing a database of known infected file signatures; and
a data processor arranged to scan said file to determine whether or not the file has a signature corresponding to one of the signatures contained in said database.

23. The apparatus according to claim 22, wherein, in order to determine whether or not the file has a signature corresponding to one of the signatures contained in said database, said data processor is arranged to derive a signature of the file and to compare the derived signature with signatures in the databases.

24. A computer memory encoded with executable instructions representing a computer program for causing computer system to:
maintain a database of known infected file signatures; and
determine whether or not the file has a signature corresponding to one of the signatures contained in said database.

25. A computer memory according to claim 24, wherein the computer program causes the files to be scanned to determine whether or not they contain a signature corresponding to one of signatures contained in the database.

26. The computer memory according to claim 24, wherein in order to determine whether or not the file has a signature corresponding to one of the signatures contained in said infected file database, said computer program causes the computer system to derive a signature of the file and to compare the derived signature with signatures in the database.

27. A method according to claim 1, wherein a match condition causes an alert or notification to be sent electronically to the user of the local computer system hosting said database.

28. A method according to claim 1, wherein a match condition causes an alert or notification to be sent electronically to a network administrator of a remote server.

29. The apparatus according to claim 22, wherein, is a part of a network firewall device.

30. The apparatus according to claim 22, wherein, is a part of a network IDS (Intrusion Detection System).

31. The apparatus according to claim 22, wherein, is a part of a network IPS (Intrusion Prevention System).

32. The apparatus according to claim 22, wherein, is a part of a network packet sniffer software.

33. The apparatus according to claim 22, wherein, is a part of a PDA (Personal Digital Assistant).

34. The apparatus according to claim 22, wherein, is a part of a digital camera.

35. The apparatus according to claim 22, wherein, is a part of a cellular phone.

36. The apparatus according to claim 22, wherein, is a part of a wireless device.

37. The apparatus according to claim 22, wherein, is a part of a computer system comprising one or more CPUs (Central Processing Unit) and one or more memories.

38. A method according to claim 1, wherein the said database is a part of a bidirectional system for sending and receiving partial hash signatures.

39. A method according to claim 38, wherein partial hash signatures are sent and received through a bidirectional request protocol set to determine a percentage of said file used in hash computation.

40. A method according to claim 39, wherein the requested percentage is set by a dynamic request protocol based on communication speed.

41. A method according to claim 39, wherein the requested percentage is set by a dynamic request protocol based on file size.

42. Apparatus for determining a partial file hash signature:
a memory storing a database of known infected file signatures; and
a memory storing a database of partial file signatures; and
a data processor arranged to scan said file incrementally and add file hash signatures, upon request, to said database of partial file signatures; and
to add said hash signatures, upon request, to said database of infected file signatures.

43. The apparatus according to claim 42, wherein the percentage scanned and imputed into said partial file signature database is set by a bidirectional electronic data protocol.

44. The apparatus according to claim 43, wherein the said bidirectional electronic data protocol contains a field of type contained in said protocol.

45. The apparatus according to claim 44, wherein the said protocol is communicated electronically over a computer network.

46. The apparatus according to claim 42, wherein the said partial file hash signature is computed through reverse computation based on probability of a match condition between said partial file and said infected file signature database.

47. The apparatus according to claim 43, wherein the said bidirectional electronic data protocol contains a field of length contained in said protocol.

48. The apparatus according to claim 47, wherein the said field of length is communicating the numerical value of the percent of a hash computed.

49. The apparatus according to claim 42, wherein the said determination of partial file hash signatures is modified based on block size of end user system when compared to block size on a remote server.
